(19) United States
(12) Patent Application Publication
(10) Pub. No.: US 2016/0274992 A1
(43) Pub. Date: Sep. 22, 2016

(54) METHOD AND MULTI-CORE PROCESSING SYSTEM FOR TRACING PROGRAM EXECUTION STATE

(71) Applicant: Wistron NeWeb Corp., Hsinchu (TW)

(72) Inventor: Ching-Jung Chen, Hsinchu (TW)

(21) Appl. No.: 14/994,146

(22) Filed: Jan. 13, 2016

(30) Foreign Application Priority Data
Mar. 16, 2015 (TW) 104108309

(51) Int. Cl. G06F 11/34; G06F 11/30

(52) U.S. Cl. CPC G06F 11/3495; G06F 11/302

(57) ABSTRACT

Method and multi-core processing system for tracing program execution state are provided, and the method includes following steps. A processor is provided, wherein the processor includes a first core and a second core. An operating system is executed by the first core, and a program is executed by the second core. During a period where the program is executed by the second core, an execution state of the second core is traced by the first core using a tracing module, so as to obtain raw execution data generated by the program executed by the second core. The raw execution data associated with the program is stored.

### CROSS-REFERENCE TO RELATED APPLICATION

This application claims the priority benefit of Taiwan application serial no. 104108309, filed on Mar. 16, 2015. The entirety of the above-mentioned patent application is hereby incorporated by reference herein and made a part of this specification.

### BACKGROUND OF THE INVENTION

1. Field of the Invention

The invention relates to a program debugging method, and more particularly, to a method and a multi-core processing system for tracing program execution state.

2. Description of Related Art

At present, a processor is generally used as a control center in many electronic devices. The processor executes software programs in order to provide various functions for the electronic device. The software program may include an operating system, an application program, a driver program and so on. Generally, when a system crash occurs on the electronic device, a user or a program designer may not necessarily be clearly informed of where the problems occur. Although the existing operating system is capable of storing an upload of a core memory before the crash occurs as reference information for debugging, such reference are merely fragment information recorded at the moment when the crash occurs, rather than being used to solve the problems or completely reproduce a process where the problems occur.

Further, during a process where the program is executed by the processor, some errors may appear only if the entire program is continuously executed. Accordingly, it is quite often that the program designer is unable to know the reason why the errors occur for sure based on the fragment information. In other words, it will take a lot of time and effort for the program designer who intends to reproduce the same errors for debugging. Worse yet, in the case where data regarding the program execution is insufficient, some of the scenarios causing the errors to occur may not be completely reproduced.

### SUMMARY OF THE INVENTION

Accordingly, the invention is directed to a method and a multi-core processing system for tracing program execution state, which are capable of completely recording an executing processing of a program executed by one of multiple cores, so as to facilitate in developing software programs.

The invention proposes a method for tracing program execution state, and the method includes the following steps. A processor is provided, wherein the processor includes a first core and a second core. An operating system is executed by the first core, and a program is executed by the second core. During runtime of the program executed by the second core, an execution state of the second core is traced by the first core using a tracing module, so as to obtain raw execution data generated by executing the program by the second core. The raw execution data associated with the program is stored.

In an embodiment of the invention, before the step of executing the operating system by the first core and executing the program by the second core, the method further includes the following steps. The first core and the second core are initialized so that the first core is in a run state and the second core is in a ready state. An initialization procedure for the operating system is executed and the tracing module is registered to the operating system by the first core when the first core is in the run state.

In an embodiment of the invention, after the step of executing the initialization procedure for the operating system and registering the tracing module to the operating system by the first core when the first core is in the run state, the method further includes the following steps. The second core is transferred from the ready state to the run state.

In an embodiment of the invention, the step of storing the raw execution data includes the following steps. The raw execution data belonging to a machine language format is converted into the raw execution data belonging to a low-level language format. The raw execution data belonging the low-level language format is stored into a storage device.

In an embodiment of the present invention, the storage device is an external storage device or an internal storage device.

In an embodiment of the present invention, the step of tracing the execution state of the second core by the first core using the tracing module during the runtime of the program executed by the second core so as to obtain the raw execution data generated by executing the program by the second core includes the following steps. At least one command associated with the program is sequentially recorded by a register of the second core during the runtime of the program executed by the second core. The at least one command is recorded into the raw execution data by the first core using the tracing module.

In an embodiment of the present invention, the method further includes the following steps. A programming language converting module is provided, and the raw execution data is converted into a traced program code belonging to a high-level language format by using the programming language converting module.

In an embodiment of the invention, the processor further includes a third core, and the method further includes the following steps. Another program is executed by the third core. The third core is traced by the first core using the tracing module during runtime of the another program executed by the third core so as to obtain another raw execution data generated by executing the another program by the third core. The another raw execution data associated with the another program is stored.

From another perspective, the invention proposes a multi-core processing system, which includes a memory and a processor coupled to each other. The processor includes a first core and a second core. The memory stores an operating system and a tracing module. An operating system is executed by the first core, and a program is executed by the second core. During runtime of the program executed by the second core, a execution state of the second core is traced by the first core using a tracing module, so as to obtain raw execution data generated by executing the program by the second core. The first core transmits the raw execution data associated with the program to a storage device so as to store the raw execution data.

Based on the above, in the embodiments of the invention, during the period where the program is executed by the second core, the first core that operates the operating system is capable of tracing the execution state of the second core by using the tracing module, so as to obtain the raw execution data based on the program executed by the second core. In other words, the first core in the multi-core processor is configured to execute the operating system and the second core in the multi-core processor is configured to the application program or the driver program. Also, the first core is further configured to trace and record the raw execution data (e.g., commands being fetched, parameters generated by executing the commands and access states of registers) during the runtime of the program executed by the second core.

To make the above features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a multi-core processing system according to an embodiment of the invention.

FIG. 2 is a flowchart illustrating a method for tracing program execution state according to an embodiment of the invention.

FIG. 3 is a schematic diagram illustrating a multi-core processing system according to an embodiment of the invention.

FIG. 4 is a flowchart illustrating a method for tracing program execution state according to an embodiment of the invention.

FIG. 5 is a schematic diagram illustrating a method for tracing program execution state according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The term “coupling/coupled” used in this specification (including claims) may refer to any direct or indirect connection means. For example, “a first device is coupled to a second device” should be interpreted as “the first device is directly connected to the second device” or “the first device is indirectly connected to the second device through other devices or connection means.” Moreover, wherever appropriate in the drawings and embodiments, elements/components/steps with the same reference numerals represent the same or similar parts. Elements/components/steps with the same reference numerals or names in different embodiments may be cross-referenced.

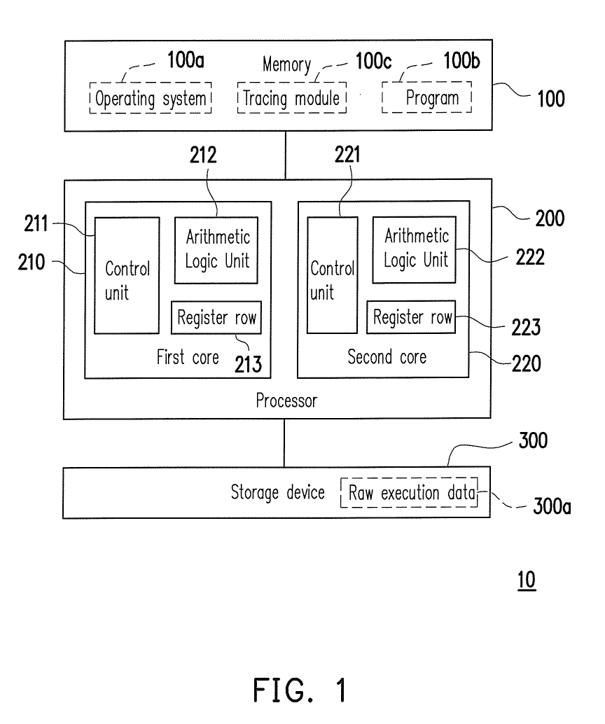

FIG. 1 is a schematic diagram illustrating a multi-core processing system according to an embodiment of the invention. Referring to FIG. 1, a multi-core processing system 10 of the present embodiment includes a memory 100, a processor 200 and a storage device 300. The processor 200 is coupled to the memory 100 and the storage device 300.

The memory 100 is, for example, a random access memory (RAM), a read-only memory (ROM), a flash memory, or other storage mediums, which are not particularly limited in the invention. The memory 100 is stored with software components for the processor 210 to access and execute. In the present embodiment, the memory 100 is stored with an operating system 100a, a program 100b and a tracing module 100c. The operating system 100a is a program that manages hardware and software resources of a computer unit, such as the Linux operating system, but the invention is not limited thereto.

The program 100b may be an application program or a driver program of a hardware equipment. For instance, the program 100b may be the driver program of a Universal Serial Bus (USB) transmission interface, or the program 100b may also be the application program having music playing functions, but the invention is not limited thereto. It should be noted that in the present embodiment, the operating system 100a and the program 100b are both stored in the memory 100, but the invention is not limited thereto. In other embodiments, the operating system 100a and the program 100b may also be stored in different storage mediums, respectively. For instance, the operating system 100a may be stored in a system memory, and the program 100b may be stored in an internal hard disk or an external hard disk. In the present embodiment, the tracing module 100c may be a software program or commands stored in the memory 100, and configured to trace the program 100b executed by the processor 200.

The processor 200 is a multi-core processor that includes a plurality of cores, but an amount of the cores in the processor 200 is not particularly limited. Only, in order to clearly describe the invention, a dual-core processor is used as example in the present embodiment, but the invention is not limited thereto. The processor 200 includes a first core 210 and a second core 220. The first core 210 and the second core 220 are, for example, ARM developed by ARM company, H8/300 developed by Hitachi company, System/370 developed by IBM company, X86 and X86-64 developed by Intel company, Motorola 68000 developed by Motorola company, MIPS developed by MIPS company, PA-RISC developed by HP company, but the invention is not limited to the above.

The first core 210 includes a control unit (CU) 211, an arithmetic logic unit (ALU) 212 and a register row 213. The control unit 211 is responsible for controlling a data flow and a command flow, and the arithmetic logic unit 213 is responsible for perfoiming arithmetic operations and logic operations. In brief, the first core 210 fetches the commands and transmits data by the control unit 211, and the arithmetic logic unit 213 performs operations and processes according the commands fetched by the control unit 211. The register row 213 may include a plurality of registers, which are used by the first core 210 for temporarily storing data and recording a run state. For instance, the register row 213 may include an accumulator, an address register, a command register, a program counter or a flag register, which are not particularly limited in the invention.

Similarly, the second core 220 includes a control unit 221, an arithmetic logic unit 222 and a register row 223. Functions of the control unit 221, the arithmetic logic unit 222 and the register row 223 are respectively identical or similar to the functions of the control unit 211, the arithmetic logic unit 212 and the register row 213, and thus related descriptions thereof are not repeated hereinafter.

The storage device 300 is coupled to the processor 200 for allowing the processor 200 to perform data accessing. The storage device 300 may be an internal storage device or an external storage device. The so-called internal storage device refers to a storage equipment in the electronic device that is identical to where the processor 200 is disposed. The so-called external storage device refers to a storage equipment in an electronic device different from the electronic device where the processor 200 is disposed. For instance, the storage device 300 may be a USB drive, or a NAND flash memory in the same electronic device where the processor 200 is disposed.

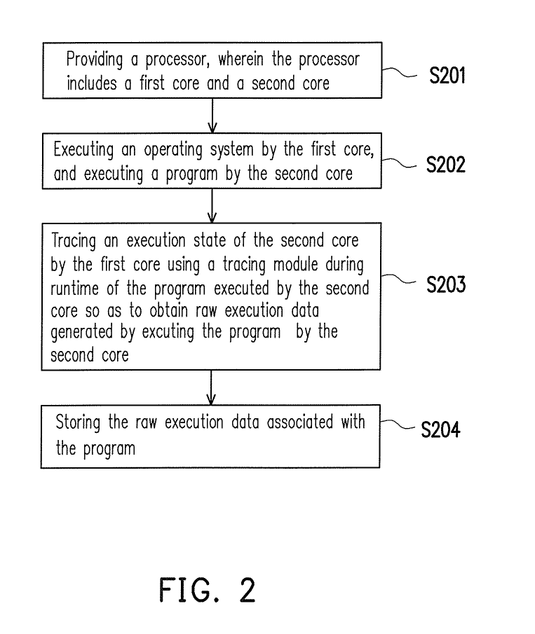

FIG. 2 is a flowchart illustrating a method for tracing program execution state according to an embodiment of the invention. The method of the present embodiment is suitable for the multi-core processing system 10 depicted in FIG. 1, and detailed steps of the present embodiment are described by using each module and each element depicted in FIG. 1 with reference to FIG. 2.

In step S201, the processor 200 is provided, wherein the processor 200 includes the first core 210 and the second core 220. Thereafter, in step S202, the first core 210 executes the operating system 100a, and the second core 220 executes the program 100b. In other words, the first core 210 and the second core 220 execute different tasks, respectively. The first core 210 executes the operating system 100a in order to manage the hardware and software resources for the entire system, and the second core 220 executes the program 100b in order to complete specific functions.

In step S203, during runtime of the program 100b executed by the second core 220, an execution state of the second core 220 is traced by the first core 210 using the tracing module 100c, so as to obtain raw execution data 300a based on the program 100b executed by the second core 220. More specifically, when program 100b is executed by the second core 220, the control unit 221 of the second core 220 fetches the commands recorded in the program 100b from the memory 100, and decodes the commands into operations that can be processed by the arithmetic logic unit 212. In the present embodiment, the first core 210 executes the tracing module 100c in order to trace the execution state of the program 100b. Specifically, during a process where the program 100b is executed by the second core 220, the tracing module 100c records the registers of the register row 223 used by the second core 220 and internal data of said registers. For instance, by sequentially recording the content in the command register, the commands used to be executed by the second core 220 may be completely recorded into the raw execution data. In step S204, the storage device 300 stores the raw execution data 300a associated with the program 100b. In other words, the first core 210 transmits the raw execution data 300a associated with the program 100b to the storage device 300 so as to store the raw execution data 300a. Accordingly, by recording the raw execution data 300a, the program designer is able to discover the errors that cannot be found by a program compiler, such as a read/write error of a memory address.

However, implementation of the invention is not limited to the above, and the content of the foregoing embodiment may be changed based on actual demands. For example, in other embodiments of the invention, the raw execution data may be converted from a low-level language format into a high-level language format, such that the program designer may understand the actual execution state of the program executed by the second core more quickly and easily. Furthermore, the tracing module may also record the data in the address register of the register row to generate the raw execution data including the memory address, so as to obtain a read/write state of the memory address during the period where the program is executed. In addition, by controlling a state transfer for the first core and the second core, a situation where the run state of the program cannot be completely recorded due to the reason that the program is already executed by the second core before the tracing module is executed by the first core may then be avoided. An embodiment is provided below for detailed description.

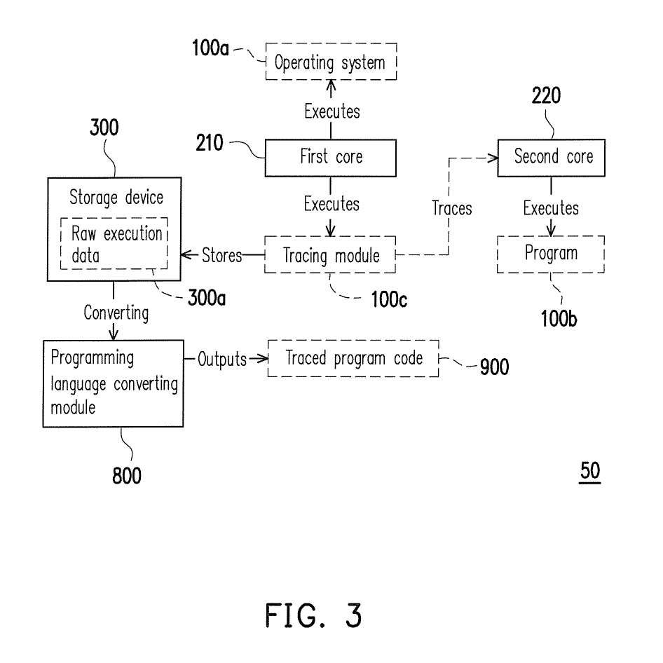

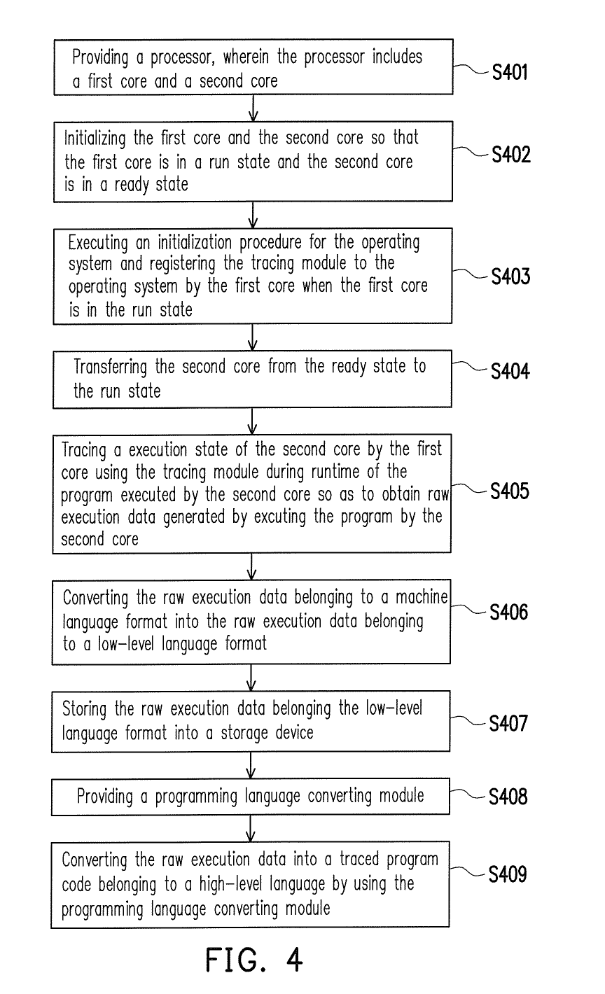

FIG. 3 is a schematic diagram illustrating a multi-core processing system according to an embodiment of the invention. FIG. 4 is a flowchart illustrating a method for tracing program execution state according to an embodiment of the invention. It should be noted that, a multi-core processing system 50 of the present embodiment further includes a programming language converting module 800. The programming language converting module 800 may be obtained through implementations of a software element, a hardware element or a combination thereof, which are not particularly limited by the invention. The software element is, for example, the software programs such as a source code, an application software and so on. The hardware element is, for example, a central processor unit, or other programmable hardware circuits for general purposes or special purposes.

Referring to FIG. 3 and FIG. 4, in step S401, a processor is provided, wherein the processor includes the first core 210 and the second core 220. In step S402, the first core 210 and the second core 220 are initialized so that the first core 210 is in the run state and the second core 220 is in a ready state. In other words, before the operating system 100a is executed by the first core 210 and the program 100b is executed by the second core 220, the first core 210 executes a hardware initialization and is in the run state whereas the second core 220 executes the hardware initialization and is in a ready state.

In step S403, when the first core 210 is in the run state, an initialization procedure for the operating system 100a is executed and the tracing module 100c is registered to the operating system 100a by the first core 210. As such, the operating system 100a may schedule the tracing module 100c as the task to be executed by the first core 210. When the first core 210, the operating system 100a and the tracing module 100c are all ready, in step S404, the second core 220 transfers from the ready state to the run state. In step S405, during runtime of the program 100b executed by the second core, the execution state of the second core 220 is traced by the first core 210 using the tracing module 100c, so as to obtain raw execution data 300a based on the program 100b executed by the second core 220.

In step S406, the raw execution data 300a belonging to a machine language format is converted into the raw execution data 300a belonging to a low-level language format. More specifically, the commands in the program 100b executed by the second core 220 are already encoded as the machine language format, that is, a combination sequence of “0” and “1”. Accordingly, the tracing module 100c may convert the raw execution data 300a belonging to the machine language format into the raw execution data 300a belonging to the low-level language format by, for example, converting the raw execution data 300a belonging to a binary sequence into an assembly language with simple commands.

Thereafter, in step S407, the raw execution data 300a belonging the low-level language format is stored into the storage device 300. In step S408, the programming language converting module 800 is provided. In step S409, the raw execution data 300a is converted into a traced program code 900 belonging to a high-level language format by using the programming language converting module 800. The programming language converting module 800 is capable of converting the raw execution data 300a belonging to the low-level language format into the traced program code 900 of the high-level language format. The low-level language format is, for example, an assembly language, and the high-level language format is, for example, the C language or the C++ language. That is to say, in the present embodiment, the raw execution data 300a may be stored in the memory device 300 in a manner of assembly language codes. As such, when the program designer wishes to understand the run state of the program 100b, the programming language converting module 800 may convert the raw execution data 300a into the traced program code 900 belonging to the high-level language format. As a result, the program designer is able to understand an execution history of the program 100b executed by the second core 220 according to the traced program code 900 which is easier to read.

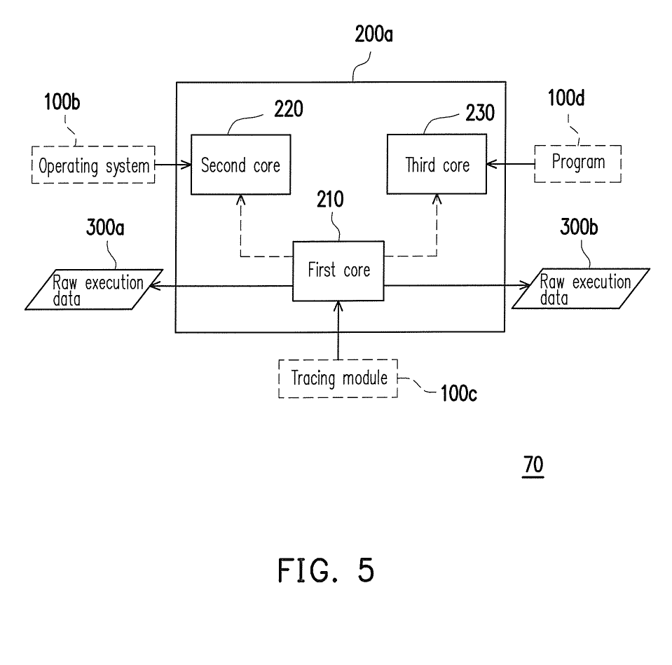

Although the foregoing embodiments are all described by using the first core and second core for example, the invention is not limited thereto. In other embodiments, the first core may use the tracing module to trace the execution states of two or more programs which are executed by different processing cores, respectively. FIG. 5 is a schematic diagram illustrating a method for tracing program execution state according to an embodiment of the invention. Referring to FIG. 5, in addition to the first core 220 and the second core 230, a processor 200a of the present embodiment further includes a third core 230. In the present embodiment, the first core 210 executes the tracing module 100c, so as to trace access states and data of the registers of the program 100b executed by the second core 220 and a program 100d executed by the third core 230.

As similar to the above, the second core 220 executes the program 100b. During a period where the program 100b is executed by the second core 220, the second core 220 is traced by the first core 210 using the tracing module 100c, so as to obtain raw execution data 300a based on the program 100b executed by the second core 220. On the other hand, the third core 230 executes the program 100d. During runtime of the program 100b is executed by the third core 230, the third core 230 is traced by the first core 210 using the tracing module 100c, so as to obtain raw execution data 300b based on the program 100d executed by the third core 230. As a result, the first core 210 may transmit the raw execution data 300a associated with the program 100b and the raw execution data 300b associated with the program 100d to the storage device, so as to store the raw execution data 300a and the raw execution data 300b.

In summary, according to the embodiments of the invention, the first core in the multi-core processor is configured to execute the operating system and the second core in the multi-core processor is configured to the application program or the driver program. Also, the first core is further configured to trace and record the raw execution data (e.g., the commands being fetched, parameters generated by executing the commands and the access states of the registers) during the period when the program is executed by the second core. As a result, the program designer is able to learn the execution history in details according to the complete raw execution data and even able to discover the errors that cannot be found by the program compiler from the complete raw execution data, such that the convenience in developing the software program may be improved.

Although the present disclosure has been described with reference to the above embodiments, it will be apparent to one of ordinary skill in the art that modifications to the described embodiments may be made without departing from the spirit of the disclosure. Accordingly, the scope of the disclosure will be defined by the attached claims and not by the above detailed descriptions.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for tracing program execution state, comprising:
providing a processor, wherein the processor comprises a first core and a second core;
executing an operating system by the first core and executing a program by the second core;
tracing an execution state of the second core by the first core using a tracing module during runtime of the program executed by the second core so as to obtain raw execution data generated by executing the program by the second core; and
storing the raw execution data associated with the program.

2. The method for tracing program execution state according to claim 1, wherein before the step of executing the operating system by the first core and executing the program by the second core, the method further comprises:
initializing the first core and the second core so that the first core is in a run state and the second core is in a ready state; and
executing an initialization procedure for the operating system and registering the tracing module to the operating system by the first core when the first core is in the run state.

3. The method for tracing program execution state according to claim 2, wherein after the step of executing the initialization procedure for the operating system and registering the tracing module to the operating system by the first core when the first core is in the run state, the method further comprises:
transferring the second core from the ready state to the run state.

4. The method for tracing program execution state according to claim 1, wherein the step of storing the raw execution data comprises:
converting the raw execution data belonging to a machine language format into the raw execution data belonging to a low-level language format; and
storing the raw execution data belonging the low-level language format into a storage device.

5. The method for tracing program execution state according to claim 1, wherein the step of tracing the execution state of the second core by the first core using the tracing module during the runtime of the program executed by the second core so as to obtain the raw execution data generated by executing the program by the second core comprises:
sequentially recording at least one command associated with the program by a register of the second core during the runtime of the program executed by the second core; and
recording the at least one command into the raw execution data by the first core using the tracing module.

6. The method for tracing program execution state according to claim 1, wherein the step of tracing the execution state of the second core by the first core using the tracing module during the runtime of the program executed by the second core so as to obtain the raw execution data generated by executing the program by the second core comprises:
recording at least one memory address associated with the program by an address register of the second core during the runtime of the program executed by the second core; and
recording the memory address in the address register into the raw execution data by the first core using the tracing module.

7. The method for tracing program execution state according to claim 1, further comprising:
providing a programming language converting module; and
converting the raw execution data into a traced program code belonging to a high-level language format by using the programming language converting module.

8. The method for tracing program execution state according to claim 1, wherein the processor further comprises a third core, and the method further comprises:
executing another program by the third core;
tracing the third core by the first core using the tracing module during runtime of the another program executed by the third core so as to obtain another raw execution data generated by executing the another program by the third core; and
storing the another raw execution data associated with the another program.

9. A multi-core processing system for tracing program execution state, comprising:
a memory, storing an operating system and a tracing module;
a first core, coupled to the memory and executing the operating system; and
a second core, coupled to the memory and executing a program,
wherein the first core traces a execution state of the second core by using the tracing module during runtime of the program executed by the second core so as to obtain raw execution data generated by executing the program by the second core,
wherein the first core transmits the raw execution data associated with the program to a storage device so as to store the raw execution data.

10. The multi-core processing system for tracing program execution state according to claim 9, wherein the second core comprises a register which sequentially records at least one command associated with the program during the runtime of the program executed by the second core, and the first core records the at least one command into the raw execution data by using the tracing module.

11. The multi-core processing system for tracing program execution state according to claim 9, wherein the second core comprises an address register which records at least one memory address associated with the program during the runtime of the program executed by the second core, and the first core records the at least one memory address into the raw execution data by using the tracing module.

12. The multi-core processing system for tracing program execution state according to claim 9, wherein before the operating system is executed by the first core and the program is executed by the second core, the first core executes a hardware initialization and is in the run state and the second core executes the hardware initialization and is in a ready state,
wherein the first core executes an initialization procedure for the operating system and registers the tracing module to the operating system when the first core is in the run state.

13. The multi-core processing system for tracing program execution state according to claim 10, wherein after the initialization procedure for the operating system is executed and the tracing module is registered to the operating system by the first core, the second core transfers from the ready state to the run state.

14. The multi-core processing system for tracing program execution state according to claim 9, wherein the first core converts the raw execution data belonging to a machine language format into the raw execution data belonging to a low-level language format.

15. The multi-core processing system for tracing program execution state according to claim 9, wherein the storage device is an external storage device or an internal storage device.

16. The multi-core processing system for tracing program execution state according to claim 9, further comprising:
a programming language converting module, coupled to the storage device, and converting the raw execution data into a traced program code belonging to a high-level language format.

17. The multi-core processing system for tracing program execution state according to claim 9, further comprising:
a third core, executing another program,
wherein the first core traces the third core by using the tracing module during runtime of the another program executed by the third core so as to obtain another raw execution data generated by executing the another program by the third core,
wherein the first core transmits the another raw execution data associated with the another program to the storage device so as to store the another raw execution data.
